(19) United States
(12) Patent Application Publication
(10) Pub. No.: US 2016/0312784 A1
(43) Pub. Date: Oct. 27, 2016

(54) SUBMERSIBLE PUMP WITH COOLING SYSTEM FOR MOTOR THROUGH SURROUNDING WATER

(71) Applicant: SONA PUMPS, Gujarat (IN)

(72) Inventor: Ankur Natwarlal Patel, Vijapur (IN)

(73) Assignee: SONA PUMPS, Gujarat (IN)

(21) Appl. No.: 14/727,380

(22) Filed: Jun. 1, 2015

(30) Foreign Application Priority Data
Apr. 24, 2015 (IN) 1664/MUM/2015

(51) Int. Cl. F04D 13/08; H02K 5/132; H02K 9/19

(52) U.S. Cl. CPC F04D 13/086; H02K 9/19; H02K 5/132

(57) ABSTRACT

A submersible Pump with Cooling System for Motor through Surrounding Water consists of a pump assembly and a motor assembly. Said pump assembly pumps is adapted to pump the water from sump and transfer it to the desired location. Said motor assembly operates the pump assembly comprises a stator body that defines the plurality of perforations from which surrounding water ingress and comes in contact with a stator winding of a stator stack accommodated in the stator body. Thus, heat of the stator stack and its winding is taken away by surrounding water. Also, heat of a rotor that is surrounded by a rotor can/shell/partition having an outer surface concentric with the stator stack is dissipated into surrounding water. The shell is filled with oil to keep cool and lubricate ball bearings.

### FIELD OF INVENTION

The present invention generally relates to a submersible water pump and more particularly it relates to a submersible water pump having expeditious cooling system for providing cooling to the motor assembly especially motor windings by heat convection through surrounding water.

### BACKGROUND OF THE INVENTION

Generally, submersible water pumps are effectively employed for lifting water from sump and other water reservoirs like bore well, open well, for dewatering purpose and also in line boosting application by enclosing the body of the pump in outer shell. In said submersible pumping system, motors are typically used to pump the water. These motors may be single phase or three phase as per requirement. In today's complex and frequently rugged process plant environments, many pumps run nearly non-stop 24-hours a day over multiple shifts. During the continuous working of submersible pumping system, the motor typically used in such system generates considerable heat that must be removed to prolong the life of motor. This is due to fact that the motor being installed in the pump is not subjected to the worked with ambient temperature and hence such poor operating conditions can reduce pump performance, require extra maintenance, shorten their lives and increase costs.

Hence, such systems require coolant that maintains the temperature of motor during its working. Heretofore many technologies have been innovated to attain this object. For this purpose canned motor pump has been used since long time. In this type of pump, the motor and the pump hydraulic parts are contained in a hermetically sealed case. Here, the winding is usually wound in an insulated stator sheet stack and encapsulated by metallic can. However, in case of defect in the pump motor winding portion in this pump, the entire shell with wound stator must be replaced and generally cannot be reused. This leads to scrap or discard of the winding and can that is quite cumbersome and time consuming. Hence, the considerable portion of the overall operating cost of such pump is governed by repair cost.

The submersible pump having wet type motor windings are provided with wet winding in order to maintain the temperature of motor. The motors with enclosed winding either with wet winding or filled with resin/gas, the cooling efficiency of such arrangement is comparatively less. All the motors with enclosed winding does not allow outside water to pass through stator winding and hence cooling efficiency is comparatively lesser then the invention.

In addition to this, in said conventional pumping system, a large portion of cost goes to journal bearings and thrust bearings due to water cooling of the bearings.

However, the foregoing technique for promoting the electric motor's dissipation by enclosing the winding in hermetical and watertight enclosure is quite complicated in structure and expensive in nature. Hence, it is desperately needed to invent a submersible pump that is a simple, relatively law cost and having open loop cooling system for an electric motor powered submersible pump.

### OBJECT OF THE INVENTION

The main object of present invention is to provide a Submersible Pump with cooling system for motor through surrounding water whereby surrounding water directly circulates through the motor for providing convection cooling to the motor winding.

Another object of present invention is to provide a Submersible Pump with cooling system for motor through surrounding water with lower fabrication cost and free from drawbacks from earlier systems of canned or wet motors.

Yet another object of the invention is to provide a Submersible Pump with cooling system for motor through surrounding water which is economical and easy to disassemble and reassemble whereby the stator winding not be discarded or scrapped for repair and analysis purposes.

Further object of present invention is to provide a Submersible Pump with cooling system for motor through surrounding water that uses low friction ball bearings to provide significant performance and reduces the required amount of oil for adequate lubrication.

Still another object of present invention is to provide a Submersible Pump with cooling system for motor through surrounding water that is susceptible to use in various water pumping related applications.

Still another object of present invention is to provide a Submersible Pump with cooling system for motor through surrounding water that insures a compact design and calls for a simpler piping systems.

### SUMMARY OF THE INVENTION

The present invention relates to a submersible pump that is adapted with cooling system for motor assembly by surrounding water throughout the stator body. It comprises a pump assembly and a motor assembly that are drivably connected to each other. Said pump assembly contains a water intake section to introduce surrounding water in the pump body and an outlet section for discharging the water at the desired location. Said motor assembly comprises a removable and cylindrical stator body that allows the surrounding water to enter inside thereof by a plurality of perforations for cooling of the components assembled therein. The surrounding water is pass to the stator stack and the stator winding so that heat of the stator assembly is absorbed and conveyed through the surrounding water. A rotor and a rotor can/shell/partition received concentrically within the stator stack are thermally contacted with the stator stack so that heat of the rotor and the rotor ca/shell/partition is also transferred from the outer surface of the stator stack to the surrounding water through thermal conduction.

### DETAILED DESCRIPTION OF THE DRAWING

Objects and advantages of the invention will be apparent from the following detailed description taken in conjunction with the accompanying figures of the drawing wherein:

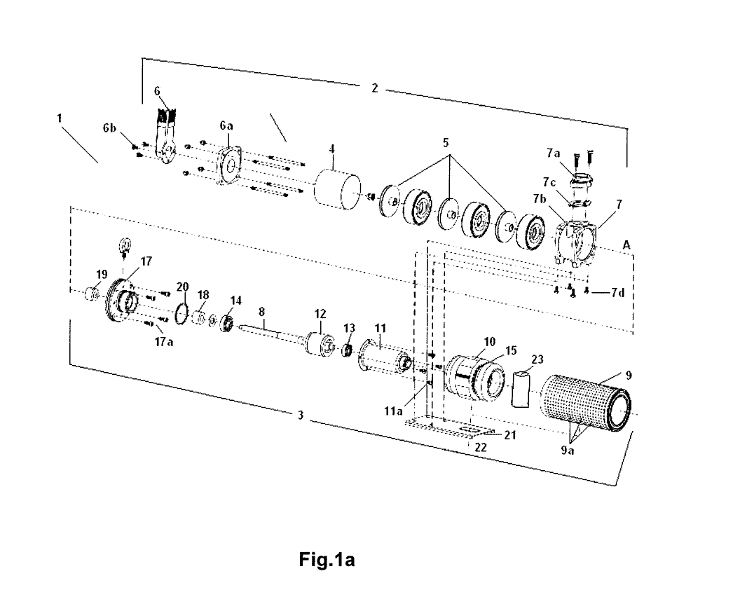

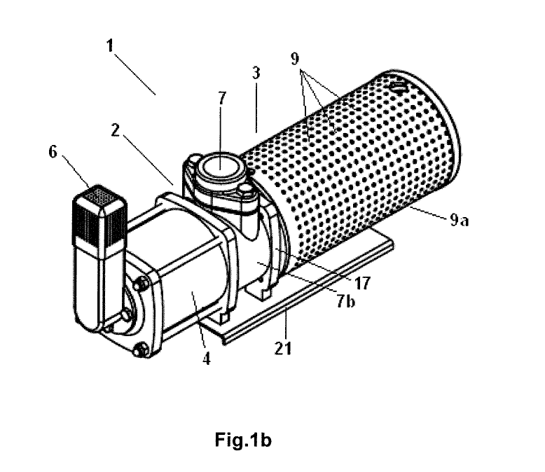

FIG. 1a is an exploded view of a submersible pump having a pump assembly and a motor assembly.

FIG. 1b shows a perspective view of the submersible pump having a pump assembly and a motor assembly.

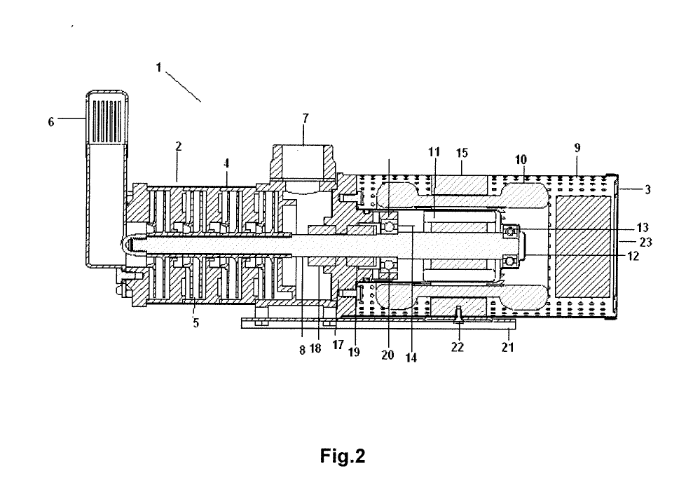

FIG. 2 is a sectional view of submersible pump according to present invention that is configured to dispose within open well.

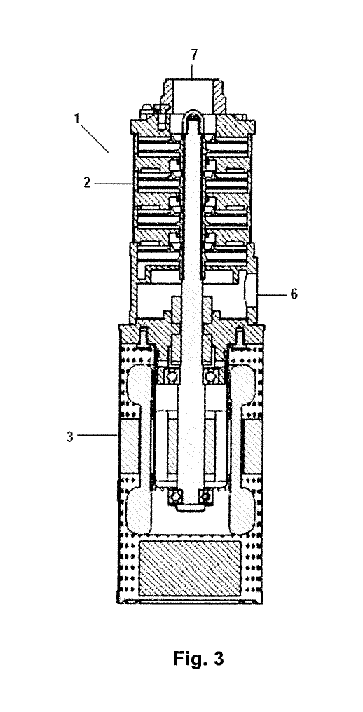

FIG. 3 is a sectional view of the submersible pump in accordance with an embodiment.

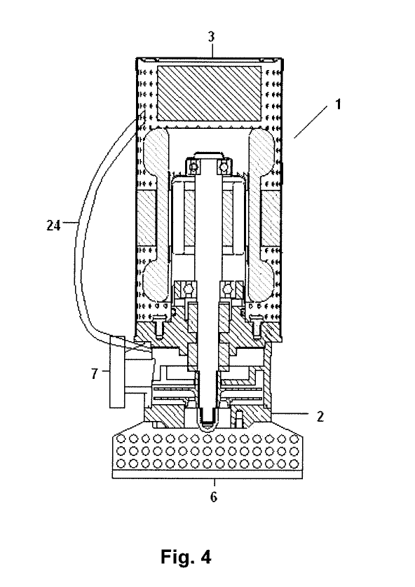

FIG. 4 is a sectional view of the submersible pump in accordance with an alternative embodiment.

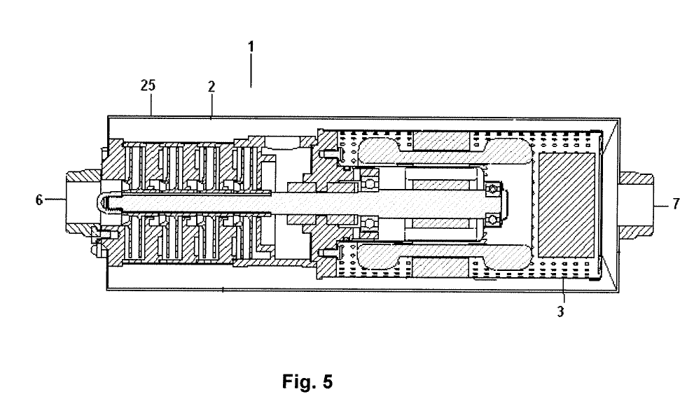

FIG. 5 is a sectional view of the submersible pump in accordance with another alternative embodiment.

### DETAILED DESCRIPTION OF THE INVENTION

Before explaining the present invention in detail, it is to be understood that the invention is not limited in its application to the details of the construction and arrangement of parts illustrated in the accompany drawings. The invention is capable of other embodiments, as depicted in different figures as described above and of being practiced or carried out in a variety of ways. It is to be understood that the phraseology and terminology employed herein is for the purpose of description and not of limitation.

It is to be noted that the term “motor” includes the “motor assembly”. Also, it is to be noted that fastening means employed herein are not limited to bolts and screws but they can be substituted by other fastening means as deemed fit according to the requirement.

FIG. 1a is an exploded perspective view of a submersible pump (1) in accordance with the present disclosure. Now, as illustrated in the FIG. 1a and FIG. 1b, the components of the submersible pump (1) are shown generally co-axially aligned with respect to an axis (A). According to present invention, said submersible pump (1) comprises of a pump assembly (2) and a motor assembly (3). Said motor assembly (3) is adapted to be drivably connected to the pump assembly (2) through a shaft (8) which is rotatable with respect to the axis (A) of the submersible pump (1). Said pump (1) may be a centrifugal pump or rotary pump.

The pump assembly (2) includes a pump body (4) within which plurality of stages of impellers and diffusers (5) are rotatably positioned to intercept and centrifugally throw the water entering through an intake section (6) provided on one side of the pump body (4) and to pump the water through an outlet section (7) fixed with the other side of the pump body (4) so that complete pump assembly is achieved. Said water intake section (6) is fixed on a suction casing (6a) using fasteners (6b) and the whole assembly is fixed with the pump body (4). Said outlet section (7) has a threaded flange connection (7a) that is mounted on a delivery casing (7b) through a gasket (7c) and connectable to the external pipe line unit (not shown) for supplying to the desired location. Said delivery casing (7b) is secured on a base plate (21) through bolts (7d) for reducing vibration during operation of the pump (1). Said impellers (5) are engaged on the shaft (8) such that the rotational torque of the shaft (8) is imparted to the impeller (5) so that the impellers (5) rotate along with the shaft (8).

Said motor assembly (3) comprises a removable and cylindrical stator body (9) with a stack of stator laminations (10) stacked along a portion of the stator body (9) inner diameter. Said stator body (9) is designed with plurality of perforations (9a). This lamination stator stack (10) is a generally annular member, and is fitted in the stator body (9). Said stator body (9) is perforated and formed of stainless steel or mild steel or any synthetic resin material selected so that the heat dissipation ability can be improved as compared to the case where interior of the stator body is purged with air. A rotor can/shell/partition (11) having cylindrical shape is disposed within the internal diameter of the stator stack (10) such that inner surface of the stator stack (10) and outer surface of the rotor can/shell/partition (11) are adjoined to enable the thermal conduction between their surfaces. A rotor (12) located within the cylindrical portion of the rotor can/shell/partition (11) is drivably connected to the shaft (8). Said rotor can/shell/partition (11) separates the rotor (12) and the stator stack (10). In the embodiment shown, the rotor (12) is attached to the shaft (8) such that rotation of the rotor (12) necessarily produces corresponding rotation of the shaft (8). Bearings (13, 14) having a generally annular body that are positioned at selected locations over a length of the shaft (8) have an outer diameter in contact with the inner diameter of the stator lamination stack (10) and an inner diameter coupled with the outer diameter of the shaft (8). These bearings (13, 14) are preferably low friction ball bearings so that required amount of oil can be reduced for lubrication with compared to conventionally used journal bearings and thrust bearings. Said Bearings (13, 14) reduce frictional rotation of the shaft (8) and also concentrically align the shaft (8) about the axis (A) within the pump body (4) and the stator body (9). Said bearings (13, 14) are lubricated and cooled by edible oil filled inside the rotor can/shell/partition (11) and thereby cooling inside the rotor can/shell/partition (11) also becomes efficient by means of edible oil lubrication. Corresponding stator windings (15) are formed within the stator lamination stack (10) and when energized cause the shaft (8) rotates for driving said pump assembly (2). Said stator windings (15) are enclosed by a waterproof coating or taping or casting for electrically insulating from the heat conducting water. An annular flange (17) fixed with the delivery casing (7b) using bolts (17a) is carrying mechanical seals (18, 19) and the bearing (14) that can be pressed against a o-ring (20) seated in cylindrical projection of the flange (17). Said rotor can/shell/partition (11) is fixed with the flange (17) using bolts (11a). Said Mechanical seals (18, 19) are adapted for isolating the motor assembly (3) and the pump assembly (2) from bearing lubrication inside the rotor can/shell/partition (11) and restraining the leakage of pumping fluid around the shaft (8).

Said stator body (9) along with the stator lamination stack (10) is firmly held in position by securing it with the base plate (21) through a screw (22). Also, said stator body (9) is fixed firmly with the flange (17) so that the pump assembly (2) and the motor assembly (3) form a complete unit. Said stator windings (15) are connected via a waterproof cable (not shown) with a waterproof commutated electronic circuitry (23) which is generally adapted in a winding protection cap (not shown) mounted within said stator body (9) for rendering power supply to the stator windings (15) through which magnetic field is generated in the stator windings (15) so that interaction of the rotor magnetic field and the stator windings magnetic field causes the rotor (12) and thus the shaft (8) and the impeller (5) to rotate thereby moving water from the inlet section (6) to the outlet section (7) of the pump assembly (2);

In accordance with this construction, the pump assembly (2) and the motor assembly (3) are configured in such a way that the water being pumped through the pump assembly (2) is kept separate from the water drawn into the stator body (9) for cooling the motor assembly. Moreover, during the troubleshooting of said submersible pump (1), the structure according to present invention is facilitated to remove the stator stack (10) and the stator winding (15) from the submersible pump (1) by removing of the outer stator body (9) and thus reuse the stator winding, stator stack and stator body without dismounting and damaging the rotor can/shell/partition and rotor and other electricals so that manufacturing cost can be reduced.

Now, various embodiments are possible in the construction of the submersible pump (1) when it is put in use for different application. Here potential embodiments are illustrated for understanding of working of said pump (1) in accordance with different applications.

According to one embodiment of present invention as shown in FIG. 2, a submersible pump (1) is kept in horizontal orientation suited for installation in open well but it could be inclined as per requirement as discussed below. Here, the submersible pump (1) is submerged in the open well such that the intake section (6) and the stator body (9) always remain in water so that maximal amount of surrounding water can ingress in the stator body (9). The water being pumped is entered through the water intake section (6) and flow out through the outlet section (7) through said pump assembly (2) by rotating the impellers (5). However, conventionally said pumped water is past through the motor winding for cooling the motor. Whereas according to present invention, the surrounded water purposely enters into the stator body (9) through the perforations (9a) and is introduced directly around the stator stack (10) and the stator winding (15) so that the heat generated by the stator stack (10) and the stator windings (15) gets dissipated in the surrounding water. Said stator body (9) allows continuous flow of surrounding water in or out through the perforations (9a) so that the heat generated by the stator stack (10) and the stator windings (15) is dissipated into the surrounding water and thereby cooled by fresh water every time. Moreover, the stator windings (15) is rest on the outer surface the rotor can/ shell/partition (11) for providing thermal conduction between the surfaces of the stator stack (10) and the rotor can/shell/partition (11) so that the heat inside the rotor can/shell/partition (11) and the rotor (12) is transferred to the stator stack (10) from outer surface of the rotor can/shell/partition (11) through said thermal conductive relation and thereby ultimately is conducted away into the surrounding water. Further, the heat generated by the commutating electronics circuit (23) is also dissipated in surrounding water circulated surrounding therethrough.

FIG. 3 shows another embodiment of a submersible pump (1) that is configured to utilize in borewell with vertical orientation. In said embodiment, the pump assembly (2) is mounted above the motor assembly (3). Here, the outlet section (7) is secured on upper side of the pump body (4) so that it can be directly connected to the external pipe for extracting and drawing sump water up to the earth surface. Here, surrounding water is also entered in the stator body (9) through the perforation (9a) that provides cooling to the different components of the 4812-3632-1828.1 motor assembly (3) as described above. It is to be noted that according this embodiment, the submersible pump (1) should be submerged into the water such that the intake section (6) and the stator body (9) always remain in the water.

According to another embodiment of present invention as shown in FIG. 4 where the submersible pump (1) is configured to suitable for dewatering purpose, the pump assembly (2) is kept below the motor assembly (3) in such a way that the intake section (6) is secured at the lower end of the pump body (4) so that maximum amount of water can be suctioned from the sump or other water reservoirs in which said pump (1) is plunged. Here, the coolant also ingress into the stator body (9) through the perforation (9a) for providing cooling to the motor assembly (3) in aforesaid manner. However, during dewatering process, the level of surrounding water is descended up to the level where adequate flow of surrounding water can not be entered in the stator body (9). To meet this requirement, a water circulating tube (24) is optionally adapted externally between the pump assembly (2) and the motor assembly (3) through which the sump water is imparted up to the stator body (9) from pump body (4) for cooling the component of the motor assembly (3) in aforesaid manner.

In another embodiment as shown in FIG. 5, where the submersible pump (1) according to present invention is utilized as in-line pump, the pump assembly (2) and the motor assembly (3) are placed in the outer shell (25). The surrounding water is introducing in the stator body (9) for cooling the motor assembly (3) in aforesaid manner. Here, the suction (intake section) (6) and the outlet section (7) are kept inline in the same horizontal plane.

The invention has been explained in relation to specific embodiment. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

1. A submersible pump with cooling system for motor through surrounding water mainly comprises a pump assembly and a motor assembly,
Wherein said pump assembly and the motor assembly are drivably connected;
wherein said pump assembly includes a pump body within which a plurality of stages of impellers and diffusers are rotatably positioned, an intake section secured within a suction casing that is fixed with the one side of the pump body, an outlet section mounted on a delivery casing through a gasket, said delivery casing is fixed with other side of the pump body;
wherein said motor assembly comprises a removable and cylindrical stator body includes a stack of stator laminations stacked along a portion of the stator body inner diameter, an electrically insulated stator winding secured within the stator stack, a rotor rotated by an interaction with a magnetic field of the stator winding, a shaft extends through the motor assembly and the pump assembly and mounted with respect to the rotor such that rotor rotates the shaft along a axis (A), a cylindrical rotor can/shell/partition which is concentrically mounted within the internal diameter of the stator stack such that stator windings rested on the outer surface of the rotor can/shell/partition, said rotor can/shell/partition concentrically receives the rotor to separate the rotor and the stator stack, an annular flange carrying mechanical seal and fixed with the delivery casing and the rotor can/shell/partition, a waterproof coated commutated electronic circuitry for supplying power to the stator windings whereby said stator winding generates a magnetic field so that interaction of the rotor magnetic field and the stator windings magnetic field causes the rotor and thus, the shaft and the impeller to rotate thereby moving water from the inlet section to the outlet section of the pump assembly;
wherein said stator body is configured by plurality of perforations for communicating the surrounding water inside the stator body for circulation of water around the stator stack and the stator winding;
Wherein said rotor can/shell/partition is in thermal conductive relationship with the surrounding water through the stator stack so that the heat inside the rotor can/shell/partition and the rotor is dissipated in the surrounding water by thermal conduction.

2. The submersible pump with cooling system for motor through surrounding water as claimed in claim 1, wherein said stator body is preferably made from stainless steel or mild steel or any synthetic resin material.

3. The submersible pump with cooling system for motor through surrounding water as claimed in claim 1, wherein said delivery casing and the stator body are firmly secured with a base plate located below the stator body through the bolts.

4. The submersible pump with cooling system for motor through surrounding water as claimed in claim 1, wherein a plurality of bearings positioned at selected locations over the length of the shaft are preferably low friction ball bearings.

5. The submersible pump with cooling system for motor through surrounding water as claimed in claim 1, wherein said rotor can/shell/partition is filled with edible oil for lubricating and cooling the bearings.

6. The submersible pump with cooling system for motor through surrounding water as claimed in claims 5, wherein the heat of lubricant oil filled inside the rotor can/shell/partition is conducted from the outer surface of the rotor can/shell/partition.

7. The submersible pump with cooling system for motor through surrounding water as claimed in claim 1, wherein an optional circulating tube that is externally connected between the stator body and the pump body for directing the water from the pump body to the stator body for cooling the motor assembly in case of inadequate flow of the water around the stator body.

8. The submersible pump with cooling system for motor through surrounding water as claimed in claim 1, wherein said submersible pump is configured to applicable in bore well, open well, dewatering and in line boosting application and similar water related applications.
